(19) United States
(12) Patent Application Publication
(10) Pub. No.: US 2024/0229755 A1
(43) Pub. Date: Jul. 11, 2024

(54) FUEL SYSTEM AND METHOD

(71) Applicants: Paul Keener Shipp, Ypsilanti, MI (US); Erin Dmytrow, LaSalle (CA); Sean Clay, Novi, MI (US); Adam Cavanaugh, Royal Oak, MI (US)

(72) Inventors: Paul Keener Shipp, Ypsilanti, MI (US); Erin Dmytrow, LaSalle (CA); Sean Clay, Novi, MI (US); Adam Cavanaugh, Royal Oak, MI (US)

(73) Assignee: ROUSH ENTERPRISES, INC., Livonia, MI (US)

(21) Appl. No.: 13/017,986

(22) Filed: Jan. 31, 2011

Related U.S. Application Data
(60) Provisional application No. 61/299,381, filed on Jan. 29, 2010.

(51) Int. Cl. F02M 63/02; F02M 25/08

(52) U.S. Cl. CPC F02M 63/022; F02M 25/0836

(57) ABSTRACT

A fuel system and method of controlling the fuel system in an engine using a liquid propane fuel wherein a fluid pressure control module 11 having a housing 12 and plurality of solenoids 20 are provided for venting the fuel pressure in the fuel rails of the fuel system after shut down of the vehicle to reduce fuel leakage from the fuel injectors and fuel rail by having a fuel bleed 20B solenoid vent the fuel pressure in the fuel rail to an evaporative emissions canister, while other solenoids (20R, 20F and 20S) are shut, to further eliminate evaporative fuel emissions from the vehicle during engine shut down.

### CROSS REFERENCE TO RELATED APPLICATION

This application hereby claims priority to U.S. provisional patent application No. 61/299,381, entitled “FUELING SYSTEM AND METHOD FOR INTERNAL COMBUSTION ENGINES” filed 29 Jan. 2010, in the name of Shipp et al., the entire contents of which is incorporated herein for all purposes.

### FIELD OF THE INVENTION

The present invention relates generally to a fuel system and method of controlling the fuel system in an engine. More particularly, the present invention relates to a fuel system and method for the use of a liquid propane fuel for internal combustion engines.

### BACKGROUND OF THE INVENTION

The “fuel system” may be defined as the components and/or controls that include at least the fuel tank, the fuel lines, the fuel rail and the fuel injectors that distribute the fuel into the intake manifold or cylinders of an internal combustion engine. In the field of fuel systems (i.e., the components and/or controls used for transferring the fuel to and/or from a fuel storage tank to an engine), it is generally desirable that the fuel system have the ability to consistently provide fuel to the engine as required in all operational modes and conditions including during start-up (cold or warm); steady state, acceleration, deceleration and shut-down and any other conditions. It also may be desirable for the system to meet certain environmental requirements (e.g. an Evaporative Emission Test commonly referred to as a “SHED Test”—“SHED” means Sealed Housing Evaporative Determination and is the “box” in which the vehicle is placed in order to perform the Evaporative Emission Test). It also may be desirable for the system to meet other requirements (e.g. 2001 NFPA 58 regulations, http://www.nfpa.org/). Both examples of SHED and NFPA regulations are incorporated by reference and portions each may be found at the end of this application. Furthermore, the requirements noted herein should be considered exemplary due to the fact that each of the U.S. Environmental Protection Agency (EPA) and California Air Resources Board (CARB) organizations may have their own variation(s) of the SHED Test and the threshold number, the vehicle and/or fuel system must meet depends on the vehicle type/engine type and is identified in the each of the respective regulations. This system may also be applicable for engines that use fuels such as gasoline, compressed natural gas, or other hydrocarbon based fuels. Of particular interest in the present invention is meeting these and the other requirements with a fuel system that utilizes Liquefied Petroleum Gas (“propane”) as the fuel. This system may also be applicable for engines that use fuels such as gasoline, compressed natural gas, or other hydrocarbon based fuels.

To date, minimizing injector leakage has been believed to be virtually solely a function of the injector design. Due to the lack of availability of low leak injectors and/or the relative high cost thereof, it is generally known that some current fuel systems rely on the use of hydrocarbon traps to minimize the impact of injector leakage on evaporative emissions such as those measured in the SHED Tests. The cost of meeting the evaporative emissions requirements (SHED Tests) is necessarily increased by the use of hydrocarbon traps which only have a limited ability to absorb the leaked fuel. No other technology is known to be in use for controlling fuel rail pressure post engine shut down as a method of reducing fuel leakage through the injectors.

It is also believed that cold start performance is impacted by the variability in injector leakage. While it is understood that engine calibrations may be optimized to handle an expected range in injector leakage while minimizing the penalty in tailpipe emissions, the greater the fuel leakage from the injector, typically a function of, inter alia, rail pressure, temperature and engine off time, there will be a greater impact on tailpipe emissions.

### SUMMARY

An objective of the present invention is to address is to provide a fuel system and method that overcomes one or more of the issues stated above. Accordingly, in one exemplary embodiment, the fuel leakage from the injectors into the intake manifold is reduced in a method which includes the step of reducing the pressure of the fuel in the fuel rail after the step of shutting down the engine.

Due to the nature of propane, if liquid propane is present, then the pressure will be a function of the fuel temperature. In a liquid injected system, it is believed that the fuel rail may contain liquid propane at the time the engine is shut down. This will then maintain a high pressure within the fuel rail during the engine off period. Injector leakage is generally understood to be a function of the sealing ability of the injector, the fuel pressure within the fuel rail and the amount of soak time. This fuel injector leakage may cause a variation in the engine start performance and hence can have an impact on tailpipe emissions. In addition, fuel injector leakage may also impact the evaporative emission performance of the vehicle, as any fuel injector leakage will contribute to the emissions of the vehicle as measured during an evaporative SHED test.

Some of the advantages of the present invention include removing the fuel pressure from the rail to remove or limit at least one source of injector leakage, to provide the above while also providing more repeatable hot and cold starts while eliminating the influence of engine off time or ambient temperature, and reducing and/or eliminating the need for hydrocarbon traps to meet certain evaporative emissions regulations.

### DESCRIPTION OF THE DRAWINGS

FIG. 1 is a perspective view of an exemplary fuel pressure control module according to the present invention;

FIG. 2 is a partial, perspective view of the exemplary fuel pressure control module of FIG. 1 with the solenoids removed according to the present invention; and

FIG. 3 is a plurality of mode flow diagrams.

### DETAILED DESCRIPTION

Referring generally to the figures and to the tables, in one embodiment, there is shown an improved fuel system and method including at least an electro-mechanical valve body assembly 10 whose valve function and timing may be controlled electronically via a computer module, such as that located in an engine control module, and may include a uniquely developed software control algorithms for operating the valve body assembly 10. The valve body 10 operates within the fuel system of the vehicle and is connected therein for operating as a fuel pressure control module 11 for controlling the supply of fuel to the engine and for managing fuel pressure within the fuel system of the engine of the vehicle including, more particularly, to control fuel pressure after the engine stops operating to reduce the amount of evaporative emissions from the fuel injectors and/or fuel rail.

The valve body 10 may be constructed or manufactured having a machined, aluminum or metal housing 12 (or by using any other known and appropriate material or manufacturing process such as ferrous, non-ferrous, machined, cast, injection molded, etc.). The metal housing 12 includes multiple internal flow passages as described herein. A plurality of electro-mechanical solenoid valves 20 (generally) may be attached to the valve body housing 12 for controlling the operational state (i.e., open or closed) of each internal flow passage. The plurality of solenoid valves 20 are generally similar and are coupled to the housing 12 of the valve body 10 for operating a specific aspect of the valve assembly 10. The plurality of solenoid valves 20 in a solenoid valve 20F is for operating the fuel Flow Control aspect; a solenoid valve 20R is for operating the fuel Return Control aspect; a solenoid valve 20S is for operating the fuel Supply aspect; and a solenoid valve 20B is for operating the fuel Bleed aspect.

The valve body assembly 10 further includes a fuel tank return passage 31, a fuel in from left bank passage 33; a fuel out to right bank passage 34, and a fuel supply from the fuel tank passage 35. It should be understood that aspects highlighted here are for providing a fuel pressure control module 11 useful for providing effective fuel rail pressure control as described herein but other passages may be included and other added functionality may be included in the valve body assembly 10.

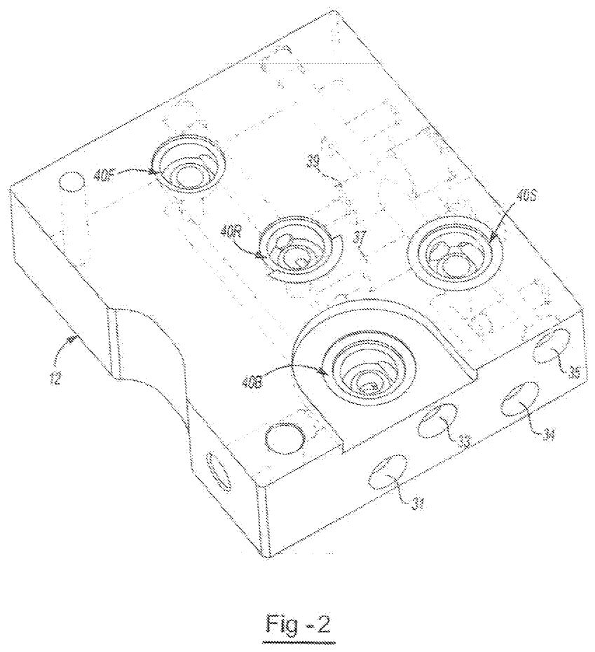

The valve body assembly 10 further includes a check valve 37 and a bypass orifice 39 as best shown in FIG. 2 and below. The check valve 37 and bypass orifice 39 each operate to help in the control of the flow of fuel through the fuel pressure control module 11. The bypass orifice 39 is selected so that supply to the fuel rails and injectors via the return orifice 39 will meet NFPA 58 regulations which do not allow for trapping of liquid propane in a closed line which may occur when the fuel supply 20S and fuel return 20R solenoids are closed. The orifice 39 allows communication from the fuel supply line 35 back to the fuel tank. The orifice 39 (or any such equivalent restriction) is appropriate selected (i.e., relatively very small) to meet NFPA 58 requirements while not materially impacting fuel supply to the engine during normal operation of the vehicle.

As will become more clear from the explanation below and the figures; to relieve pressure within the fuel rail (not shown) to which the valve body 10 is coupled, a solenoid 20 may be placed in the fuel return line between the fuel rail and the fuel tank. The solenoid 20 may be further connected to the vehicle evaporative emissions system such as by an orifice. When the engine (not shown) is shut down (such as by turning off the ignition system or through any other process) the solenoid 20 may be opened after a defined period of time. The bypass orifice 39, in particular, slows the evaporation of the fuel (i.e., propane when the fuel pressure control module 11 is used in a liquid propane gas (LPG) fuel system in an engine of a vehicle) to minimize the space velocity in to avoid breakthrough.

In one embodiment, the standard fuel vapor management valve canister purge procedure may be activated while the vehicle is running to purge the fuel (i.e., propane) from the fuel vapor management valve canister and prepare for the next shut down.

A slightly modified version of the gasoline Evaporative System OBD monitor may be used to check for about 0.020″ leaks in the system and the correct operation of the bleed solenoid 20.

Additional solenoids 20 may optionally be added to the assembly 10 to further reduce and/or to minimize the mass of propane fuel that must be captured by the carbon in the fuel vapor management valve canister while depressurizing the fuel rails (not shown). The additional solenoids 20 are located in the valve assembly 10 to close the fuel return and the fuel supply lines to the fuel rail and to open an additional path that connects the fuel return and supply lines with the orifice to allow fuel (such as the liquid propane) trapped in the fuel supply line to be returned to the fuel tank for supporting compliance of the assembly with NFPA 58 regulations.

The pressure relief of check valve 37 may be included to allow the return line 31 solenoid 20R to be bypassed when the pressure in the fuel rail increases on engine shut down due to a sufficient heat soak prior to the bleed solenoid 20B opening.

The fuel pressure flow control module include a fuel rail flush solenoid 20F incorporated into the module 11. In one embodiment of the present disclosure, as set forth in the illustrative examples below, the fuel system pressure control module 11 may be utilized to modify a gasoline fuel engine and vehicle to operate using liquid propane gas as the fuel for operating the engine of the vehicle.

Under normal engine operation, as shown below, the fuel supply 20S and the fuel return 20R solenoids will be open allowing the normal flow of fuel from the fuel tank to the fuel rails and then back to the fuel tank. Upon initial engine shut down the fuel supply 20S and the fuel return 20R solenoids will close isolating the fuel rails from the fuel tank.

When fuel rail pressure reduction is required the fuel bleed 20B solenoid may be activated to allow the propane fuel in the fuel rails to be transferred to the fuel vapor management valve canister, thus reducing the fuel pressure in the fuel rails (see Mode 3 and diagram below). While in Mode 3, fuel will collect in the fuel vapor management valve canister, the vapor management valve canister will be purged during the normal operation of the engine in the same manner as a gasoline powered vehicle through the Vapor Management Valve (VMV).

Integrity of the whole vehicle evaporative emissions system can be monitored using standard fuel leak detection techniques to determine 0.040 and 0.020″ leak paths by trapping vacuum in the system using the VMV and the canister vent solenoid and measuring the decay rate of the vacuum using the pressure transducer as will be understood after reading this disclosure.

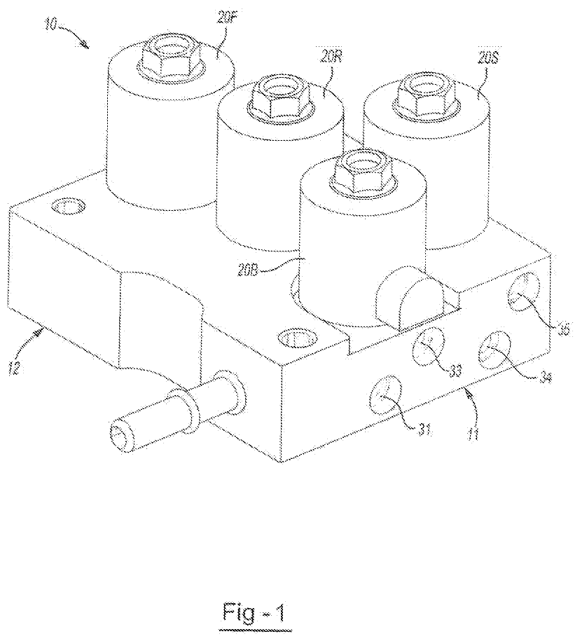

With the description above of the valve body assembly 10 and the fuel control module 11 clarified, a detailed explanation of the operational states thereof now follows. For the schematic processes explained and detailed below the following legend key applies: S=Supply Solenoid; B=Bleed Solenoid; R=Return Solenoid; F=Flush Solenoid; 1=Supply to Return orifice; 2=Return Bypass check valve; and 3=Bleed orifice similar to the legends used in describing the fuel valve body assembly in FIGS. 1-2.

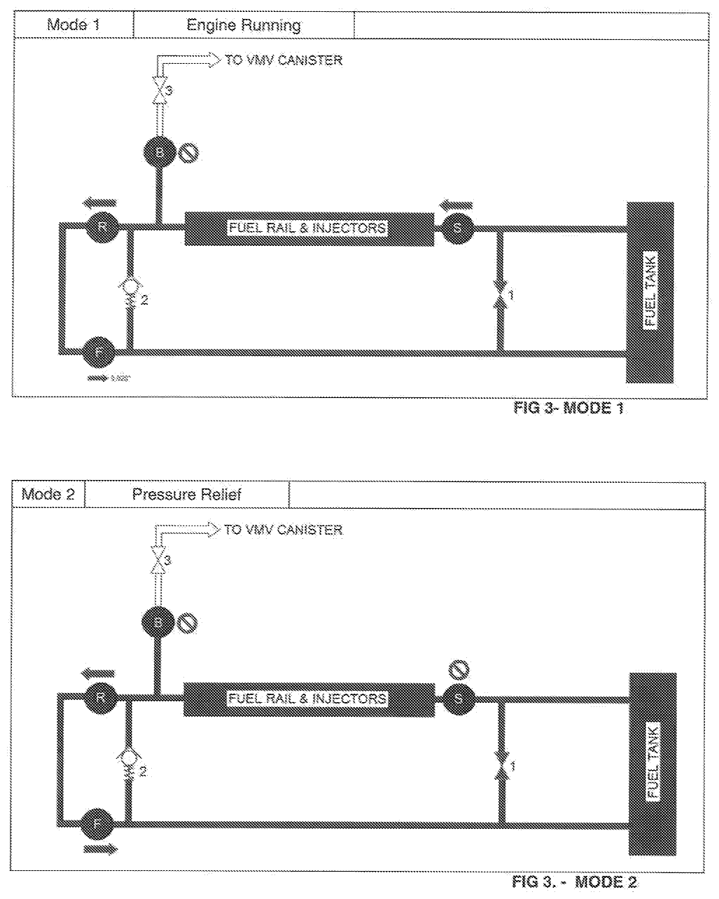

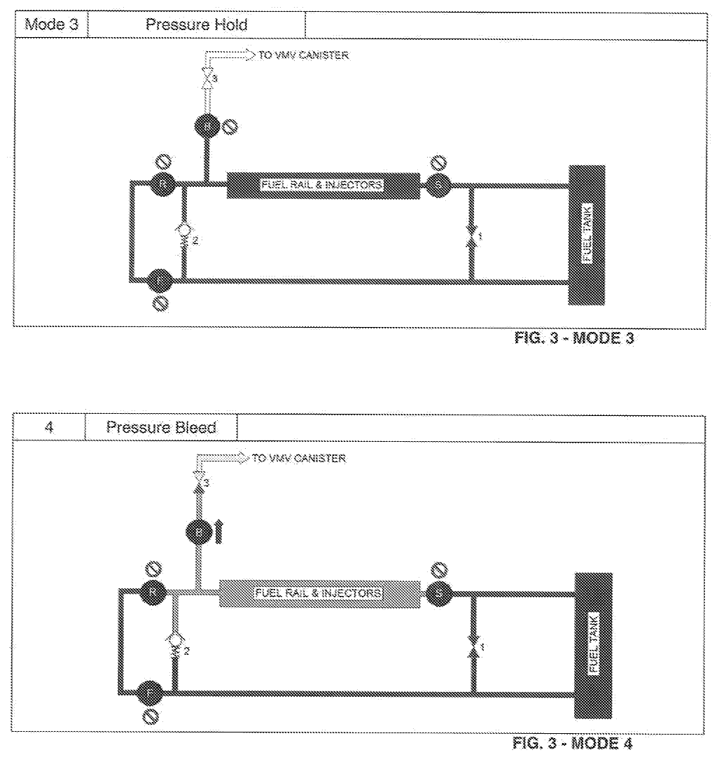

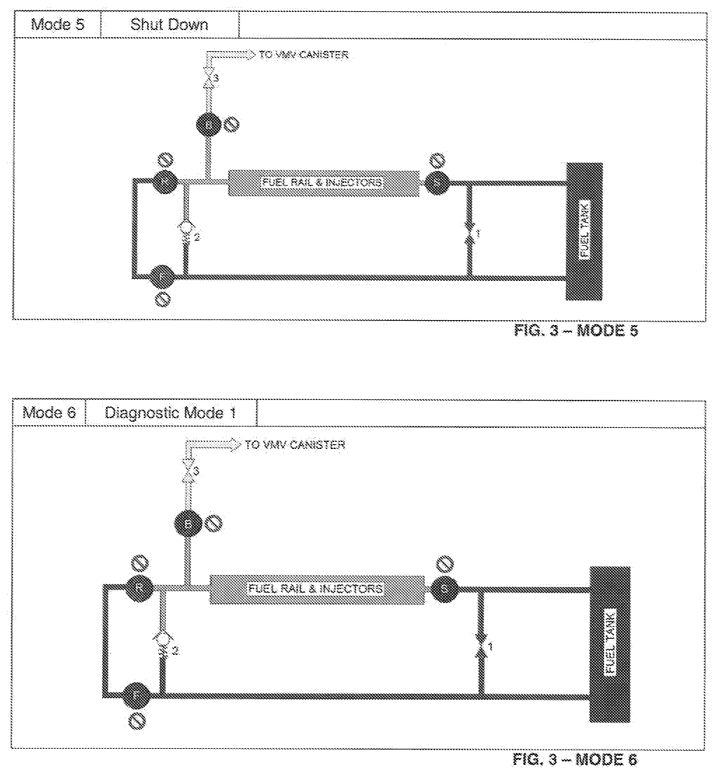

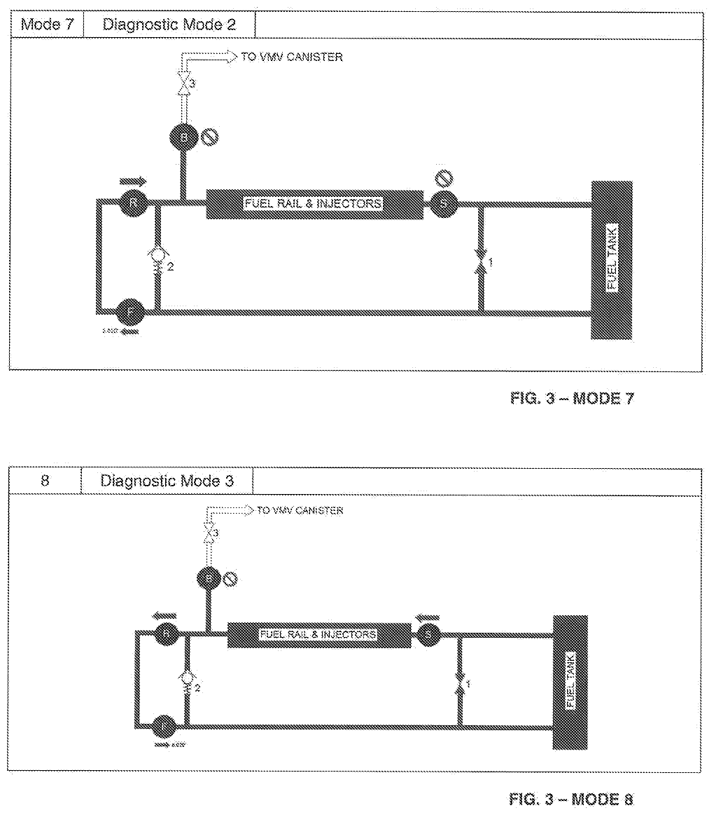

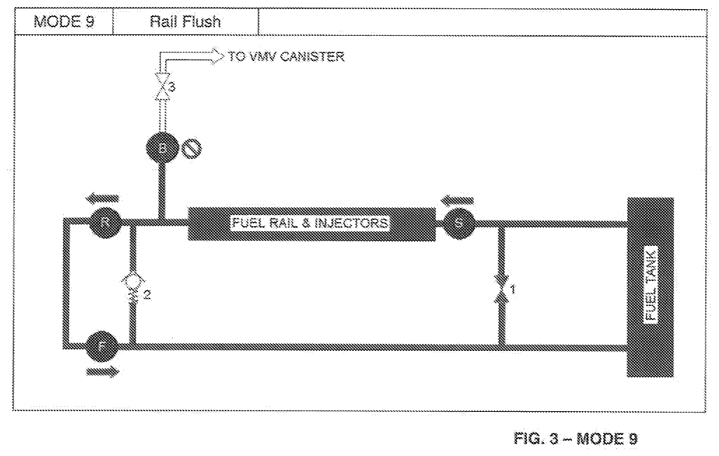

In a first or engine running mode, Mode 1 of FIG. 3, the fuel supply (20S or S) and return (20R or R) solenoids are open allowing normal fuel flow to and from the fuel tank. The bleed (20B or B) solenoid is closed sealing the evaporative emissions system (EVAP) and preventing any fuel to pass to the VMV canister. The flush (20F or F) solenoid is also closed as fuel rail flush is not required during the engine running (i.e., normal engine operating) mode. In the Mode 1 of FIG. 3 operational embodiment shown, regular evaporative fuel leak detection algorithms may be executed.

### Mode 2—Pressure Relief

In a second or pressure relief mode, Mode 2 of FIG. 3, upon initial engine shutdown, the fuel supply (20S or S) solenoid is shut to prevent further supply of fuel to the fuel rail and the injectors. At the same or sequential time, the fuel return (20R or R) and fuel flush (20F or F) solenoids are held open for a given period of time (approximately 30 seconds) to allow pressure caused by heat soak in the fuel rails to reduce and to return fuel to the fuel tank. The fuel bleed (20B or B) solenoid remains closed sealing the evaporative emissions system (EVAP) and preventing any fuel to pass to the VMV canister during the second mode.

### Mode 3—Pressure Hold

In a third or pressure hold mode, Mode 3 of FIG. 3, after the initial engine shutdown Mode 2, the fuel supply (20S or S) solenoid remains shut to prevent further supply of fuel to the fuel rail and the injectors from the fuel tank. In Mode 3, the fuel bleed (20B or B) solenoid remains closed sealing the evaporative emissions system (EVAP) and preventing any fuel to pass to the VMV canister during the second mode. At the same or sequential time, the fuel return (20R or R) and fuel flush (20F or F) solenoids are shut for a given period of time (from a relatively short period of time of a few minutes until a relatively longer period of time such as one hour) to confirm that the engine will not be restarted after a relatively short period of off time.

### Mode 4—Pressure Bleed

In a fourth or pressure bleed mode, Mode 4 of FIG. 3, after the Mode 2 and Mode 3, the fuel supply 20S solenoid remains shut to prevent further supply of fuel to the fuel rail and the injectors from the fuel tank. In Mode 4, the fuel bleed 20B solenoid is opened for a calibrated time based upon fuel rail pressure at engine shut down. Based upon the fuel rail pressure at engine shut down time (Mode 2) is set and that time duration allowed to run while the pressure in the fuel rail is allowed to bleed from the fuel rail while all other solenoids 20R, 20F and 20S remain closed from Mode 3 above. Accordingly, during Mode 4, fuel is allowed to bleed from the fuel system via the valve body assembly 10 and pass to the VMV canister for the predetermined period of time after the given period of time for Mode 3.

### Mode 5—Shut Down

In a fifth or shut down mode, Mode 5 of FIG. 3, after the predetermined period of Mode 4 is completed and the fuel pressure in the fuel rail is reduced and fuel is allowed to bleed from the fuel system via the valve body assembly 10 and pass to the VMV canister, all of the solenoids are put back in the closed position (i.e., in the embodiment shown below), and the solenoids 20 are unpowered which puts them in their normally closed position such that fuel cannot move within the fuel system.

### Mode 6—Diagnostic Mode 1

In a sixth or first diagnostic mode, Mode 6 of FIG. 3, which is initiated upon receiving a request to start the engine while the system is in the shut down Mode 5, the fuel pressure in the rail is read with all the solenoids 20 still closed, similar to Mode 5. The Mode 6 fuel pressure reading is then compared to a threshold fuel pressure rail setting against engine off time to validate that the bleed mode and system operated as intended (i.e., correctly). If the fuel rail pressure is higher than the threshold fuel pressure rail setting a fault will be set.

### Mode 7—Diagnostic Mode 2

If, in the sixth or first diagnostic mode, Mode 6 of FIG. 3, the fuel rail pressure is less than the threshold fuel pressure rail setting, then the fuel pressure control system 11 will enter the seventh of second diagnostic mode, Mode 7, wherein the return solenoid 20R is opened. When the flush solenoid 20F and the return solenoid 20R are opened, and fuel from the fuel tank is allowed to pressurize fuel in the supply and return lines to enter the fuel rails resulting in an increase in fuel pressure therein. The fuel pressure is then again compared against the threshold to determine that the solenoid did open correctly.

### Mode 8—Diagnostic Mode 3

In the eighth mode, or third diagnostic mode, after the completion of diagnostic mode 2, the supply solenoid 20S is opened and fuel is allowed to freely flow through the fuel system and the fuel pressure control module and the engine enters its normal start mode. If the fuel supply 20S solenoid does not open for any reason then the engine will not run due to the flow restriction of orifice 39 (number 1 shown in Mode 7 of FIG. 3) since there will be insufficient flow to the fuel rails and injectors.

### Mode 9—Rail Flush

After the completion of diagnostic mode 3 of FIG. 3, the fuel rail flush process is initiated to ensure liquid fuel is present in the fuel rail. The fuel flush 20F solenoid has a functional diagnostic run to verify that there is a change in fuel pressure after a state change of the flush 20F solenoid has been commanded. Based upon a successful completion of the diagnostic, as understood in the art, the fuel system is considered function and appropriate conditions exist to initiate engine ignition. Once the engine ignition is successful and the engine is operating (i.e., running), then the fuel pressure control module returns to Mode 1.

The fuel return bypass check valve (2 in the images) may be required in the event of a fuel bleed 20B solenoid failure. In this instance, the fuel return bypass check valve allows high pressure in the fuel rail to be vented to the fuel tank via the fuel return line 31. If the fuel rail pressure is higher than the fuel return line 31 and can overcome the fuel return bypass check valve spring force, then fuel pressure will be released to the fuel return line 31. The fuel bleed orifice (3 in the images, or equivalent restriction) may be required to reduce the velocity of the propane vented from the fuel rail into the fuel vapor system and to ensure that there is no break though of the carbon canister which would allow propane to vent to the atmosphere.

When the fuel supply 20S, fuel return 20R and fuel bleed 20B solenoids are normally closed with no power applied, they have preferably zero flow and are essentially sealed and the solenoids will operate to open the valves when about 12 volts is applied by the engine control module.

The fuel flush 20F solenoid may be an on/off type solenoid that is normally closed when no power is applied and is preferably also opened when about 12 volts is applied by the controller. However, for the fuel flush 20F solenoid, when the solenoid is closed, there is an approximately 0.020″ orifice in the flush valve that allows limited fuel flow back to the fuel tank. It is contemplated that this fuel flush valve orifice may be used to generate increased pressure in the fuel rail above the tank pressure by restricting the fuel pump flow to ensure that there is liquid propane available for the injectors. Accordingly, the fuel flush 20F solenoid minimizes the amount of time taken to prepare the fuel rail for engine start if propane vapor is properly detected. Notwithstanding this benefit, in one alternate embodiment, it should be understood that the fuel flush 20F solenoid may be optional and the remaining components of the fuel pressure control module 11 may be employed without the fuel flush 20F solenoid.

In the embodiment shown and discussed above, the fuel supply 20S and fuel return 20R solenoids are used to reduce the mass of propane to be stored in the VMV canister to allow for increased system robustness. It is contemplated that, despite given the above benefits, it should understood that it is possible to have an embodiment where the fuel supply 20S and fuel return 20R solenoids are optional and not used but the remaining parts of the fuel pressure control module are used.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner. It is contemplated the all values discussed herein are approximate and may vary by as much as ±10%; ±20%; and ±50% or more depending upon the factors identified as well as other aspects not discussed. The disclosures of all articles and references, including patent applications and publications, are incorporated by reference for all purposes.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The term “consisting essentially of” to describe a combination shall include the elements, ingredients, components or steps identified, and such other elements ingredients, components or steps that do not materially affect the basic and novel characteristics of the combination.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps unless specifically stated such a singular limitation is intended. All references herein to elements or metals belonging to a certain Group are intended to refer to the Periodic Table of the Elements published and copyrighted by CRC Press, Inc., 1989. Any reference to the Group or Groups shall be to the Group or Groups as reflected in this Periodic Table of the Elements using the IUPAC system for numbering groups.

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the embodiments of the present invention as set forth are not intended as being exhaustive or limiting of the invention. The scope of the invention should, therefore, be determined not with reference to the above description, but should instead be determined with reference to the appended claims, along with the full scope of equivalents to which such claims are entitled.

I claim:

1. A fuel pressure control module, comprising:
a valve body assembly having a fuel supply line connection, a fuel return line connection, a fuel rail line connection and a bleed line connection for connection to an evaporative emissions canister;
a fuel supply valve for selectively interrupting the fuel supply from the fuel tank;
a fuel bleed valve for selectively interrupting the supply of fuel from the fuel system to the evaporative emissions canister;
a fuel return valve for selectively interrupting the fuel return line;
a fuel flush valve for selectively interrupting the flow of fuel to the fuel tank;
wherein the fuel supply valve, the fuel return valve and the fuel flush valve can all be closed while the fuel bleed valve is open to reduce pressure in the fuel rail and fuel injectors to reduce the evaporative emissions there from.

2. The fuel pressure control module of claim 1 wherein the fuel supply valve, the fuel return valve, the fuel flush valve and the fuel bleed valve are each solenoid operated and are coupled to the engine control module.

3. The fuel pressure control module of claims 1 further comprising a check valve for receiving the output fuel pressure from the fuel rail and bypassing the fuel return valve and the fuel flush valve to return fuel to the fuel tank.

4. The fuel pressure control module of claim 1 further comprising an orifice valve connected between the fuel supply line and the fuel return line.

5. A fuel pressure control module include a valve body assembly having a fuel supply line connection, a fuel return line connection, a fuel rail line connection and a bleed line connection for connection to an evaporative emissions canister;
a fuel supply solenoid for selectively interrupting the fuel supply from the fuel tank;
a fuel bleed solenoid for selectively interrupting the supply of fuel from the fuel system to the evaporative emissions canister;
a fuel return solenoid for selectively interrupting the fuel return line;
a fuel flush solenoid for selectively operating the flow of fuel to the fuel tank wherein the fuel flush solenoid does not completely interrupt the fuel flow; and
wherein the fuel supply solenoid, the fuel return solenoid and the fuel flush solenoid can all be closed while the fuel bleed valve is open to reduce pressure in the fuel rail and fuel injectors to reduce the evaporative emissions there from.

6. The fuel pressure control module of claim 5 wherein the fuel flush solenoid in its closed position has an orifice of approximately 0.020″ for allowing fuel flow there through.

7. A method of operating a fuel pressure control module, wherein the fuel pressure control module includes a valve body assembly having a fuel supply line connection, a fuel return line connection, a fuel rail line connection and a bleed line connection for connection to an evaporative emissions canister; a fuel supply valve for selectively interrupting the fuel supply from the fuel tank; a fuel bleed valve for selectively interrupting the supply of fuel from the fuel system to the evaporative emissions canister; a fuel return valve for selectively interrupting the fuel return line; a fuel flush valve for selectively interrupting the flow of fuel to the fuel tank; the method comprising the steps of:
closing the fuel supply valve, the fuel return valve and the fuel flush valve; and
opening the fuel bleed valve to reduce pressure in the fuel rail and fuel injectors and to vent the evaporative emissions there from to a fuel canister to less the evaporative emissions from the fuel system.

8. The method of operating the fuel pressure control module of claim 7, further comprising the steps of, after the steps of claim 7, upon sensing a request to start the engine, closing the fuel bleed valve and sensing the pressure in the fuel rail and comparing it to a reference pressure.

9. The method of operating the fuel pressure control module of claim 7, further comprising, after the steps of claim 7, closing the fuel bleed valve, opening the fuel flush valve and the fuel return valve to raise the pressure in the fuel rail.

10. The method of operating the fuel pressure control module of claim 8, further comprising, after the steps of claim 8, opening the fuel supply valve and signaling the fuel supply system is operation for starting the engine.

11. The method of operating the fuel pressure control module of claim 8, further comprising, after the steps of claim 8, opening the fuel supply valve; verifying there is a change in fuel pressure in the fuel rail to confirm that the fuel supply valve has been opened and then signaling the fuel supply system is operation for starting the engine.
